(19) United States
(12) Patent Application Publication
(10) Pub. No.: US 2006/0102090 A1
(43) Pub. Date: May 18, 2006

(54) Aquarium tube holder

(76) Inventor: John M. Kemp, Chattanooga, TN (US)

Correspondence Address: JOHN M. KEMP, 1022 BRYNEWOOD, CHATTANOOGA, TN, 37415, US

(21) Appl. No.: 10/969,575

(22) Filed: Oct. 21, 2004

(51) Int. Cl. A01K 63/04

(52) U.S. Cl. 119/264

(57) ABSTRACT

A holder for a flexible vinyl tube used to siphon water from a fish aquarium has been designed to be affixed permanently to the inside wall of a drainage container. The holder consists of a plastic pipe attached to a curved plastic plate. The inside wall of the pipe is sized and or configured to exert an appropriate and predetermined degree of pressure against the siphon tube. When inserted in the holder, the tube is held in place. When in use, lateral and downward pressure lock the tube in place vertically but also allows for the tube to be swivelled.

### FIELD OF THE INVENTION

This invention addresses the persistent problem of controlling the typical flexible siphon tube used for fish aquariums. ⅜″, 7/16″ and ½″ flexible vinyl tubes are typically the ones now being used and furnished with fish aquarium siphon gravel vacuums.

### BACKGROUND OF THE INVENTION

Extensive research has been conducted in conjunction with the manufacture and marketing of a siphon vacuum. Such research firmly established the fact that controlling the flexible siphon tube was one of the main problems encountered when cleaning fish aquariums.

### OBJECTS AND ADVANTAGES

Research also revealed that a standard 5 gallon plastic bucket was the ideal drainage container to use. Such buckets are readily available at reasonable prices. Accordingly, solving the problem of controlling the flexible siphon tube included designing a holder that could be used on this type of container.

Although the holder was initially attached to the bucket by means of a “C” clamp, it was soon determined that affixing the holder permanently to the inside wall of the bucket was more practical.

Since the holder is on the inside of the bucket and takes up very little space, it makes it possible to use the bucket for other purposes. Clips and other attachments on the outside of the bucket interfere with its normal use. Even affixing clips and other fasteners to standard 5 gallon buckets is a challenge.

Buckets were purchased from the four main retail outlets. Each bucket had different ledges and raised areas on the upper 3 or 4 inches of the outside wall. The inside walls were, of course, smooth with the same degree of curvature.

The inside of the holder is sized to exert a predetermined degree of friction against the siphon tube. This makes it possible to easily insert the tube in the holder and maintain the proper length of tube outside of the bucket. The user simply grasps the tube at the top of the holder and shortens or lengthens the amount outside of the bucket. Clips make such adjustments difficult.

When the tube is being used, the lateral and downward pressure and the weight of the water within the tube, lock the tube in place vertically. At the same time however, the tube can be easily swivelled.

One most important advantage of this invention is associated with the starting of the siphoning process. Usually when the vacuuming commences, cessation of the vacuuming procedure takes place when the drainage container needs to be emptied. Occasionally however, there are instances during which one stops draining the aquarium before emptying the container. At this particular time, the tube is usually under the water level. Self-starting siphon vacuums need an open line to start.

If the tube is under water, using the present invention, it can be quickly raised to a point above the water level. It can then be lowered after siphoning commences.

The fact that there are no moving parts, eliminates the possibility of, for example, a clip popping loose or a hook twisting in the wrong direction. The user simply pushes the tube in the holder when starting siphoning, and withdraws it when the bucket is to be emptied. The predetermined degree of friction established within the holder assures worry-free, uncomplicated control of the flexible siphon tube. This control eliminates a very difficult to manage element in the act of siphoning water from a fish aquarium.

### DRAWINGS

FIG. 1. A holder designed to be permanently affixed to the inside wall of a standard 5 gallon plastic bucket.

FIG. 2. Holder installed.

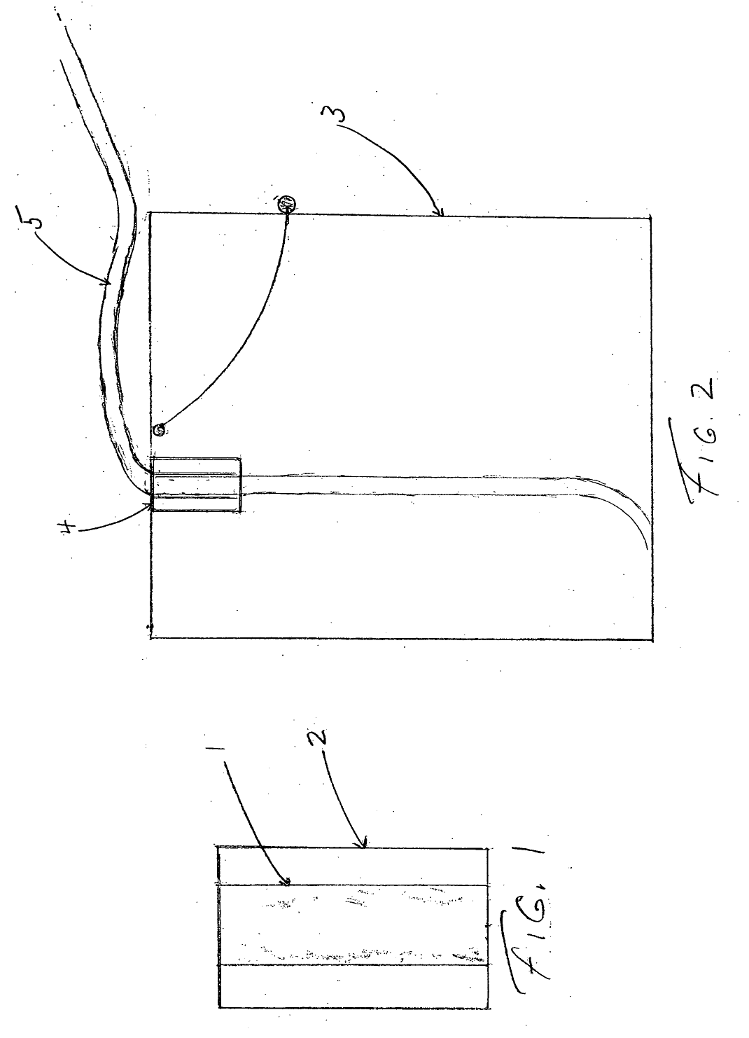

### DRAWING REFERENCE NUMERALS

1. Plastic pipe. I D sized for flexible tube.
2. Plastic plate curved to match the curvature of a standard 5 gallon plastic bucket. Plastic plate faced with double-sided tape.
3. Standard 5 gallon plastic bucket.
4. Holder
5. Siphon-tube.

### OPERATION OF INVENTION

Siphon tube 5 is inserted into holder 4. The appropriate amount of siphon tube 5 is placed inside bucket 3. The predetermined degree of friction holds the siphon tube 5 in position. When in use, the siphon tube 5 is locked in place vertically by its lateral and downward position as shown in FIG. 2. At the same time, siphon tube 5 can be easily swivelled. When siphon tube 5 is to be removed, it is withdrawn vertically.

I claim:

1. A holder for a flexible tube, the tube used to siphon water from a fish aquarium, the holder consisting of a section of hollow material, said holder designed to be attached permanently or impermanently to the inside wall of a drainage container, said holder having an inside wall that is precisely sized and or configured to exert an appropriate predetermined degree of pressure against said tube when said tube is inserted into said holder.

2. A holder according to claim 1 wherein said holder consists of a plastic pipe.

3. A holder according to claim 1 wherein said holder has an attachment, the attachment serving the purpose of securing said holder to the inside wall of the drainage container.

4. A holder according to claim 3 wherein said attachment is a plastic plate, the plastic plate having a curvature that matches the curvature of the inside wall of a standard 5 gallon plastic bucket.

5. A holder according to claim 4 wherein a section of permanent type double faced foam tape is affixed to said plastic plate, the tape covered with a film to be removed prior to affixing said holder to the inside wall of said bucket.

6. A holder according to claim 3 wherein said holder is attached to said bucket by means of an appropriate fastener such as a clamp or clip.
